(19) United States
(12) Patent Application Publication
(10) Pub. No.: US 2012/0039383 A1
(43) Pub. Date: Feb. 16, 2012

(54) CODING UNIT SYNCHRONOUS ADAPTIVE LOOP FILTER FLAGS

(75) Inventors: Yu-Wen Huang, Taipei (TW); Ching-Yeh Chen, Taipei (TW); Chih-Ming Fu, Hsinchu (TW)

(73) Assignee: MEDIATEK INC., Hsinchu (TW)

(21) Appl. No.: 12/945,897

(22) Filed: Nov. 15, 2010

Related U.S. Application Data
(60) Provisional application No. 61/373,158, filed on Aug. 12, 2010.

(51) Int. Cl. H04N 7/12

(52) U.S. Cl. 375/240.02; 375/E07.076; 375/E07.027

(57) ABSTRACT

An apparatus and method for coding unit-synchronous adaptive loop filtering (ALF) for an image area that is partitioned into a plurality of coding units are disclosed. In a conventional approach, the slice-level bitstream cannot be generated until all coding units in a slice are processed since the ALF filter coefficients are determined based on reconstructed pixels and original pixels of a slice. According to one embodiment, the method processes the coding units in the image area one after the other to generate a CU-level bitstream. The method also reconstructs the coding units to from reconstructed coding units which are subject to adaptive loop filtering. Upon the availability of reconstructed coding units for the image area, the method derives filter coefficients for the ALF filter based on the reconstructed pixels and original pixels in the image area. The designed ALF filter is then tested for each coding unit to determine whether the ALF filter should be applied to the coding unit and the decision is indicated by an ALF flag. After all ALF flags are determined, an image area header is created by incorporating the filter coefficients and ALF flags in the header. The header and the CU-level data previously created are combined into an image area level bitstream. An apparatus to perform the steps recited in the method is also disclosed.

### CROSS REFERENCE TO RELATED APPLICATIONS

The present invention claims priority to U.S. Provisional Patent Application No. 61/373,158, filed Aug. 12, 2010, entitled “Coding Unit Synchronous Adaptive Loop Filter Flags”. The U.S. Provisional Patent Application is hereby incorporated by reference in its entirety.

### FIELD OF THE INVENTION

The present invention relates to video coding. In particular, the present invention relates to coding techniques associated with adaptive loop filter.

### BACKGROUND

Video data in a digital format offers many advantages over the conventional analog format and has become the dominant format for video storage and transmission. The video data are usually digitized into integers represented by a fixed number of bits, such as 8 bits or 10 bits per sample. Furthermore, color video data are often represented using a selected color system such as a Red-Green-Blue (RGB) primary color coordinates or a luminance-chrominance system. One of the popular luminance-chrominance color systems used in digital video is the well know YCrCb color system, where Y is referred to as the luminance component and Cr and Cb are referred to as the chrominance signals. Since human vision perceives lower chrominance spatial resolution, Cr and Cb are usually captured at lower sampling rates for more compact representation. Nevertheless, digital video consumes too much bandwidth to transmit and takes too much space to store. Consequently, digital video coding has been widely used to reduce the bandwidth or storage space associated with digital video.

For digital video compression, motion compensated inter-frame coding is a very effective compression technique and has been widely adopted in various coding standards, such as MPEG-1/2/4 and H.261/H.263/H.264/AVC. In most current coding systems, the macroblock, consisting of 16×16 pixels, is primarily used as a unit for motion estimation and subsequent processing. Nevertheless, in the recent development of the next generation standard named High Efficiency Video Coding (HEVC), a more flexible structure is being adopted as a unit for processing. The unit of this flexible structure is termed as coding unit (CU). The coding unit can start with a size of a largest coding unit and is adaptively divided into smaller blocks using quadtree structure to achieve a better performance. Blocks that are no longer split into smaller coding units are called leaf CUs, and data in the same leaf CU share the same coding information. The quadtree split can be recursively applied to each of the largest CU until it reaches the smallest CU, the sizes of the largest CU and the smallest CU are properly selected to balance the tradeoff between system complexity and performance. On the other hand, loop filtering has been used in various coding systems, such as the deblocking filter in H.264/AVC, to suppress propagation of coding noise, where the loop filtered frame is used as reference data for intra/inter prediction in the coding loop. In the recent HEVC development, a loop filtering technique, called adaptive loop filtering (ALF), is applied to blocks according to the quadtree-based CU structure, and is being adopted to process the deblocked reconstruction frame. Depending on a performance criterion, the video encoder will determine whether a block (e.g. a leaf CU) is subject to ALF or not, and uses an ALF flag to signal the decision so that a decoder can apply the ALF accordingly. Since information associated with ALF processing will not be available until the processing for a whole frame, or at least a slice, is completed, the encoder has to temporarily buffer a large amount of data for the frame or slice. This will increase system memory requirement and system bus bandwidth. Consequently, it is desired to develop an apparatus and method that can relieve the need for buffering a large amount of data due to the need for waiting the ALF results.

### BRIEF SUMMARY OF THE INVENTION

An apparatus and method for coding unit-synchronous adaptive loop filtering for an image area that is partitioned into a plurality of coding units are disclosed. According to one embodiment, the method processes the coding units in the image area one after the other to generate a CU-level bitstream. The method also reconstructs the coding units to from reconstructed coding units which are subject to adaptive loop filtering. Upon the availability of reconstructed coding units for the image area, the method derives filter coefficients for the ALF filter based on the reconstructed pixels and original pixels in the image area. The designed ALF filter is then tested for each coding unit to determine whether the ALF filter should be applied to the coding unit and the decision is indicated by an ALF flag. After all ALF flags are determined, an image area header is created by incorporating the filter coefficients and ALF flags in the header. The header and the CU-level data previously created are combined into an image area level bitstream. An apparatus to perform the steps recited in the method is also disclosed.

An apparatus and method of decoding video data for a video system employing coding unit-synchronous adaptive loop filtering for an image area that is partitioned into a plurality of coding units are disclosed. The image area-level bitstream associated with the image area comprises an image area-level header and CU-level bitstreams associated with the plurality of coding units. According to one embodiment of the present in a decoder, the method receives the image area-level bitstream corresponding to the image area and extracts ALF filter coefficients and ALF flags from the image area header. Then, the method extracts a CU-level bitstream to reconstruct a coding unit. According to the ALF flag, the method applies the ALF filter to the coding unit adaptively. An apparatus to perform the steps recited in the method is also disclosed.

### BRIEF DESCRIPTION OF THE DRAWINGS

FIG. 1 illustrates a system block diagram of conventional video compression with intra/inter-prediction.

FIG. 2 illustrates an exemplary coding unit split based on quadtree.

FIG. 3 illustrates a system block diagram incorporating adaptive loop filtering to improve system performance.

FIG. 4A illustrates an exemplary ALF flags associated with blocks resulted from a quadtree split of a largest coding unit.

FIG. 4B illustrates an exemplary ALF flags associated with blocks resulted from a quadtree split of a largest coding unit, where the smallest CU is smaller than the minimum ALF block size.

FIG. 5A illustrates an exemplary data structure according to a conventional coding method.

FIG. 5B illustrates an exemplary data structure according to one embodiment of the present invention, where ALF flags are carried in the slice header for respective coding units.

FIG. 5C illustrates an alternative exemplary data structure according to one embodiment of the present invention, where ALF flags are carried in the slice header for respective coding units.

FIG. 6 illustrates an exemplary flow chart for CU-synchronous ALF according to a conventional coding method.

FIG. 7 illustrates an exemplary flow chart for CU-synchronous ALF information according to one embodiment of the present invention,.

### DETAILED DESCRIPTION OF THE INVENTION

For digital video compression, motion compensated inter-frame coding is a very effective compression technique and has been widely adopted in various coding standards, such as MPEG-1/2/4 and H.261/H.263/H.264/AVC. In most coding systems today, a macroblock of 16×16 pixels is primarily used as a unit for motion estimation and subsequent processing. Nevertheless, in the recent HEVC development, a more flexible structure is being adopted as a unit for processing which is termed as a coding unit (CU). The coding process may start with a coding unit having the largest coding unit size and then adaptively divides the coding unit into smaller blocks. The partitioning of coding units may be based on a quadtree structure splitting a coding unit into four smaller coding units with equal size. The quadtree split can be recursively applied beginning with the largest CU until it reaches the smallest CU where the sizes of the largest CU (LCU) and the smallest CU (SCU) may be pre-specified. In order to suppress propagation of coding noise (for example, quantization errors), loop filtering has been used in various coding systems, such as the deblocking filter in H.264/AVC. In the recent HEVC development, adaptive loop filtering (ALF) is being adopted to process deblocked reconstruction frames. Wiener filtering is a popular ALF applied to minimize mean square errors between original frames and deblocked reconstruction frames. ALF can be selectively turned on or off for each block in a frame or a slice. The block size and block shape can be adaptive, and the information of block size and block shape can be explicitly sent to decoders or implicitly derived by decoders. In one approach, the blocks are resulted from quadtree partitioning of LCUs. Depending on a performance criterion, the video encoder will determine whether the blocks are subject to ALF or not, and uses an ALF flag to signal the decision for each block so that a decoder can react accordingly.

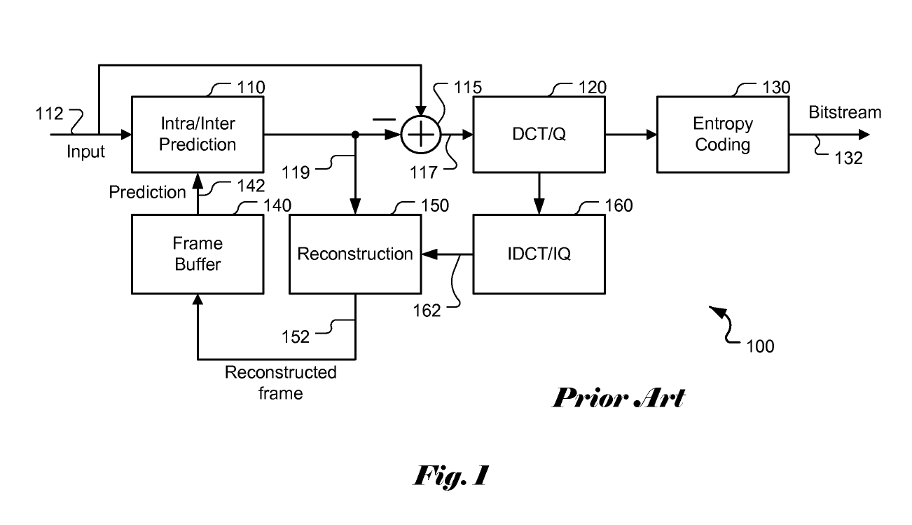

FIG. 1 illustrates a system block diagram of conventional video compression with intra/inter-prediction. Compression system 100 illustrates a typical video encoder performing intra/inter-prediction, Discrete Cosine Transform (DCT) and entropy coding to generate a bitstream with a data size smaller than original data size. The original data enter the encoder through input interface 112 and the input video data is subject to intra/inter-prediction 110. In the intra prediction mode, the incoming video data is predicted by surrounding data in the same frame or field that are already coded, and the prediction data 142 from frame buffer 140 correspond to surrounding data in the same frame or field that are already coded. The prediction may also be made within a unit corresponding to a part of picture smaller than a frame or a field, such as a stripe or slice for better error isolation. In the inter prediction mode, the prediction is based on previously reconstructed data 142 stored in frame buffer 140. The inter prediction can be a forward prediction mode, where the prediction is based on a picture prior to the current picture. The inter prediction may also be a backward prediction mode where the inter prediction is based on a picture after the current picture in display order. In the inter-prediction mode, the intra/inter prediction 110 will cause the prediction data to be provided to the adder 115 and be subtracted from the original video data. The output 117 from the adder 115 is termed the prediction error which is further processed by the DCT/Q block 120 representing Discrete Cosine Transform and quantization (Q). The DCT and quantizer 120 converts prediction errors 117 into coded symbols for further processing by entropy coding 130 to produce compressed bitstream 132, which is stored or transmitted. In order to provide the prediction data, the prediction error processed by the DCT and quantization 120 has to be recovered by inverse DCT and inverse quantization (IDCT/IQ) 160 to provide a reconstructed prediction error 162. In the reconstruction block 150, the reconstructed prediction error 162 is added to a previously reconstructed frame 119 in the inter prediction mode stored in the frame buffer 140 to form a currently reconstructed frame 152. In the intra prediction mode, the reconstructed prediction error 162 is added to the previously reconstructed surrounding data in the same frame stored in the frame buffer 140 to form the currently reconstructed frame 152. The intra/inter prediction block 110 is configured to route the reconstructed data 119 stored in frame buffer 140 to the reconstruction block 150, where the reconstructed data 119 may correspond to reconstructed previous frame or reconstructed surrounding data in the same frame depending on the inter/intra mode. In advanced video compression systems, the reconstruction block 150 not only reconstruct a frame based on the reconstructed prediction error 162 and previously reconstructed data 119, it may also perform certain processing such as deblocking and loop filtering to reduce coding artifacts at block boundaries and quantization errors. Due to various mathematical operations associated with DCT, quantization, inverse quantization, inverse DCT, deblocking processing and loop filtering, the pixels of the reconstructed frame may have intensity level changed beyond the original range and/or the intensity level may have a mean level shifted. Therefore, the pixel intensity may be properly processed to alleviate or eliminate the potential problem.

In the conventional coding as shown in FIG. 1, the video data usually are divided into macroblocks and the coding process is applied to macroblocks in an image area one by one. The image area may be a slice which represents a subset of a picture that can be independently encoded and decoded. The slice size is flexible in newer coding standard such as the H.264/AVC. The image area may also be a frame or picture as in older coding standards such as MPEG-1 and MPEG-2. The motion estimation/compensation for conventional coding system often is based on the macroblock. The motion-compensated macroblock is then divided into four 8×8 blocks and 8×8 DCT is applied to each block. The transform coefficients are then quantized and entropy coded. The compressed data associated with the transform coefficients is then packed with side information such as motion, mode, and other descriptive information of the image area. In the H.264 coding standard, the coding process for the macroblock becomes more flexible, where the 16×16 macroblock can be adaptively divided down as small as a block of 4×4 pixels for motion estimation/compensation and coding. In the recent HEVC development, a more flexible coding structure is being adopted, where the coding unit is defined as a processing unit and the coding unit can be recursively partitioned into smaller coding units. The concept of coding unit is similar to that of macroblock and sub-macro-block in the conventional video coding. The use of adaptive coding unit has been found to achieve performance improvement over the macroblock based compression of H.264/AVC.

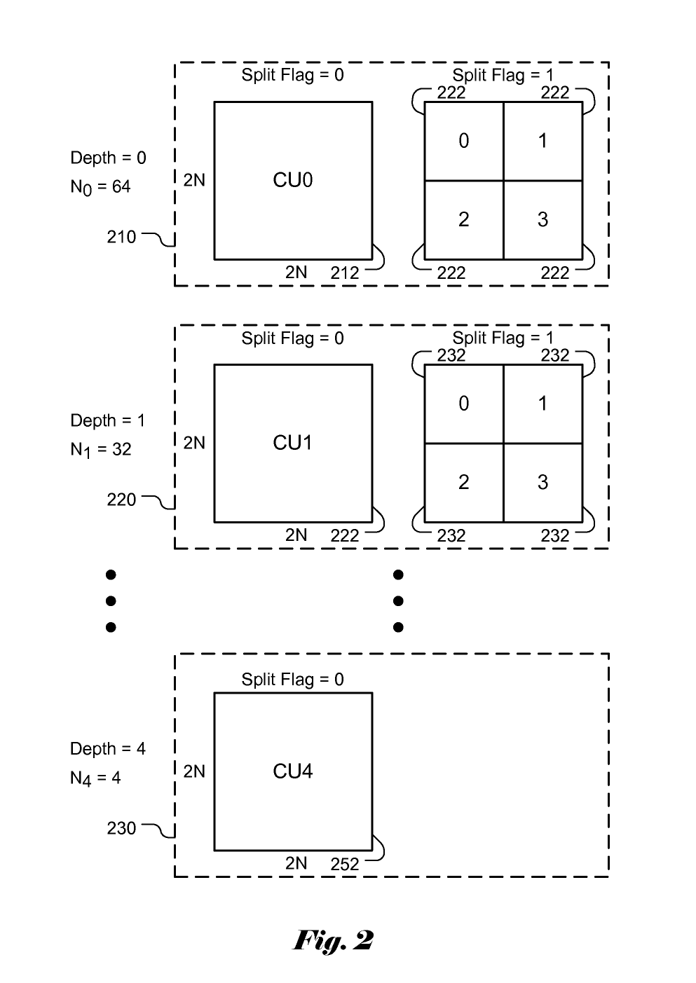

FIG. 2 illustrates an exemplary coding unit partition based on quadtree. At depth 0, the initial coding unit CU0 212 consisting of 128×128 pixel, is the largest CU. The initial coding unit CU0 212 is subject to quadtree split as shown in block 210. A split flag 0 indicates the underlying CU is not split and, on the other hand a split flag 1 indicates the underlying CU is split into four smaller coding units 222 by the quadtree. The resulting four coding units are labeled as 0, 1, 2 and 3 and each resulting coding unit becomes a coding unit for further split in the next depth. The coding units resulted from coding unit CU0 212 are referred to as CU1 222. When a coding unit is split by the quadtree, the resulting coding units are subject to further quadtree split unless the coding unit reaches a pre-specified smallest CU size. Consequently, at depth 1, the coding unit CU1 222 is subject to quadtree split as shown in block 220. Again, a split flag 0 indicates the underlying CU is not split and, on the other hand a split flag 1 indicates the underlying CU is split into four smaller coding units CU2 232 by the quadtree. The coding unit CU2 has a size of 32×32 and the process of the quadtree splitting can continue until a pre-specified smallest coding unit is reached. For example, if the smallest coding unit is chosen to be 8×8, the coding unit CU4 252 at depth 4 will not be subject to further split as shown in block 230. The collection of quadtree partitions of a picture to form variable-size coding units constitutes a partition map for the encoder to process the input image area accordingly. The partition map has to be conveyed to the decoder so that the decoding process can be performed accordingly.

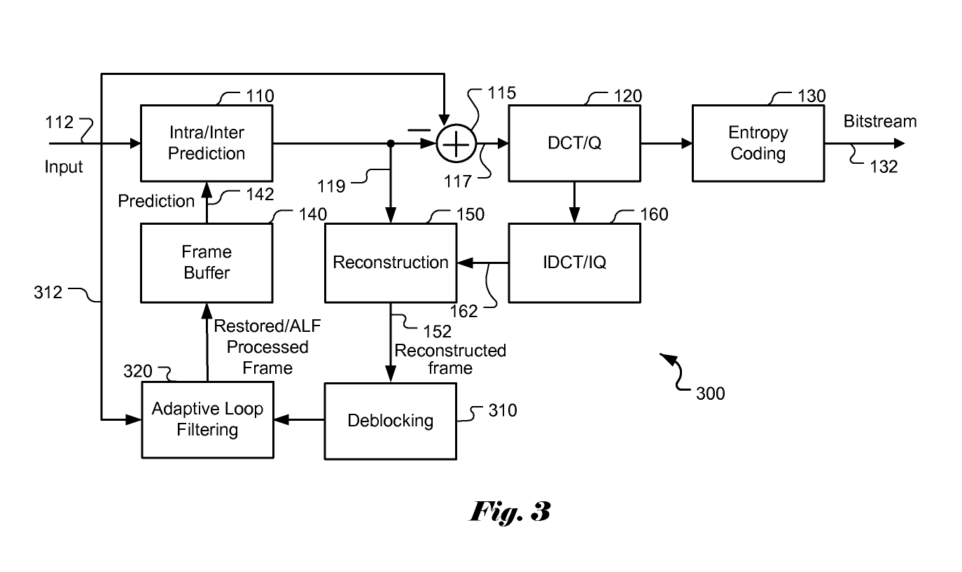

In a coding system, the reconstructed frame 152 usually contains coding noise due to quantization. Because of the block-based processing in the coding system, coding artifacts around the boundaries of the block are more noticeable. Such artifacts may propagate from frame to frame. Accordingly, in-loop filtering to “deblock” the artifacts at and near boundaries of the block has been used in newer coding systems to alleviate the artifacts and improve picture quality. The in-loop filtering applied to pixel at and near boundaries of blocks is often referred to as “deblocking”. In the recent HEVC development, additional in-loop filtering is applied to the deblocked reconstruction frame. The additional in-loop filtering is applied to these blocks where the filtering helps to improve performance. For other blocks that the filtering does not help to improve performance, the additional in-loop filtering is not applied. Accordingly, the additional in-loop filtering is called adaptive loop filtering (ALF). A system block diagram for a coding system incorporating adaptive loop filtering and deblocking is shown in FIG. 3. The reconstructed frame 152 is processed by the deblocking in-loop filtering 310 first. The deblocked reconstructed frame is further filtered by adaptive loop filtering 320. The reconstructed frame processed by deblocking and adaptive loop filtering is then stored in the frame buffer 140 as reference frames for processing of subsequent frames.

In order to apply the loop filter adaptively, loop filtering is performed on a block by block basis. If loop filtering helps to improve qualify for the underlying block, the block is labeled accordingly to indicate that loop filtering is applied. Otherwise, the block is labeled to indicate that loop filtering is not applied. The filter coefficients usually are designed to match the characteristics of the underlying image area of the picture. For example, the filter coefficients can be designed to minimize the mean square error (MSE) by using Wiener filter, which is a well known optimal linear filter to restore degradation caused by Gaussian noise. In the video compression system, the main distortion is contributed by the quantization noise which can be simply modeled as a Gaussian noise. The filter coefficient design using Wiener filter requires the knowledge of the original signal and the reconstructed signal. Accordingly, the original signal of the input image is fed to the adaptive loop filtering 320 through the signal line 312 as shown in FIG. 3. The adaptive loop filtering 320 shown in FIG. 3 serves two functions: one is to perform ALF and the other is to derive the filter coefficients based on reconstructed pixels and original pixels of the image area. The portion of the process to derive the filter coefficients may be presented by a separate block. Nevertheless, it is understood that the blocks in FIG. 3 is for the purpose of illustrating the required processing associated with ALF. Some blocks may be implemented in the same module or circuit and some blocks may be implemented using sub-modules. Merging or splitting functions or tasks associated with the blocks in the block diagram shown in FIG. 3 will not depart from the embodiment of the present invention. The MSE minimization is performed on an image area and the derived filter coefficients are specific to the image area. Therefore, the filter coefficients have to be transmitted along with the image area as side information and all blocks in the image area share the same filter coefficients. Consequently, the image area has to be large enough to reduce the overhead information associated with the filter coefficients. Usually, the image area used for deriving the filter coefficients is based on a slice or a frame. In the case of slice for deriving the filter coefficients, the filter coefficient information is carried in the slice header. A slice will be used as an exemplary image area associated with ALF coefficients derivation. It is understood that other image area, such as a frame may also be used. ALF typically uses a two-dimensional (2D) filter. Exemplary dimension of the filter used in practice may be 5×5, 7×7 or 9×9. Nevertheless, filters having other sizes may also be used for ALF. To reduce implementation cost, the 2D filter may be designed to be separable so that the 2D filter can be implemented using two separate one-dimensional filters where one is applied to the horizontal direction and the other is applied to the vertical direction. Since the filter coefficients may have to be transmitted, symmetric filters may be used to save the side information required. Other types of filters may also be used to reduce the number of coefficients to be transmitted. For example, a diamond-shaped 2D filter may be used where non-zero coefficients are mostly along the horizontal and the vertical axes and some zero-valued coefficients are in the off-axis directions. Furthermore, the transmission of filter coefficients may be compressed in a coded form to save bandwidth.

Adaptive loop filtering is applied to pixels on a block basis. If ALF helps to improve the quality for the block, the filter is turned ON for the block, otherwise it is turned OFF. The fixed block size for ALF is easy to implement and does not require side information to transmit to the decoder regarding partitioning the underlying image area. Nevertheless, in a study by Toshiba Corporation, entitled “Quadtree-based adaptive loop filter”, authored by Chujoh et al., Jan. 2, 2009, ITU Study Group 16—Contribution 181, COM16-C181-E, a quadtree based ALF is described which can further improve performance over the fixed block-based ALF. The blocks for the quadtree based ALF may not be aligned with the coding units. Therefore, partitioning information has to be transmitted to decoder to synchronize the processing. An alternative image area partition for ALF is described by Samsung Electronics Co. in “Samsung's Response to the Call for Proposals on Video Compression Technology”, by McCann et al., Apr. 15-23, 2010, Document: JCTVC-A124. McCann et al., uses blocks resulted from the quadtree-partitioned CU for ALF. The partitioning information for the quadtree-based CU is already available in the system for the coding-decoding purpose and it does not require any additional side information for the ALF to use the same partition. The ALF based on blocks resulted from partitioning CU is referred to as CU-synchronous ALF since the application of ALF is aligned with CU partitioning. Regardless of the ALF based on blocks separately partitioned or based on blocks synchronized with CU, there is a need to provide side information regarding whether the ALF operation is ON or OFF for a block. Consequently, an ALF flag is used for each block, also referred to as an ALF block, to signal whether the ALF is ON or OFF.

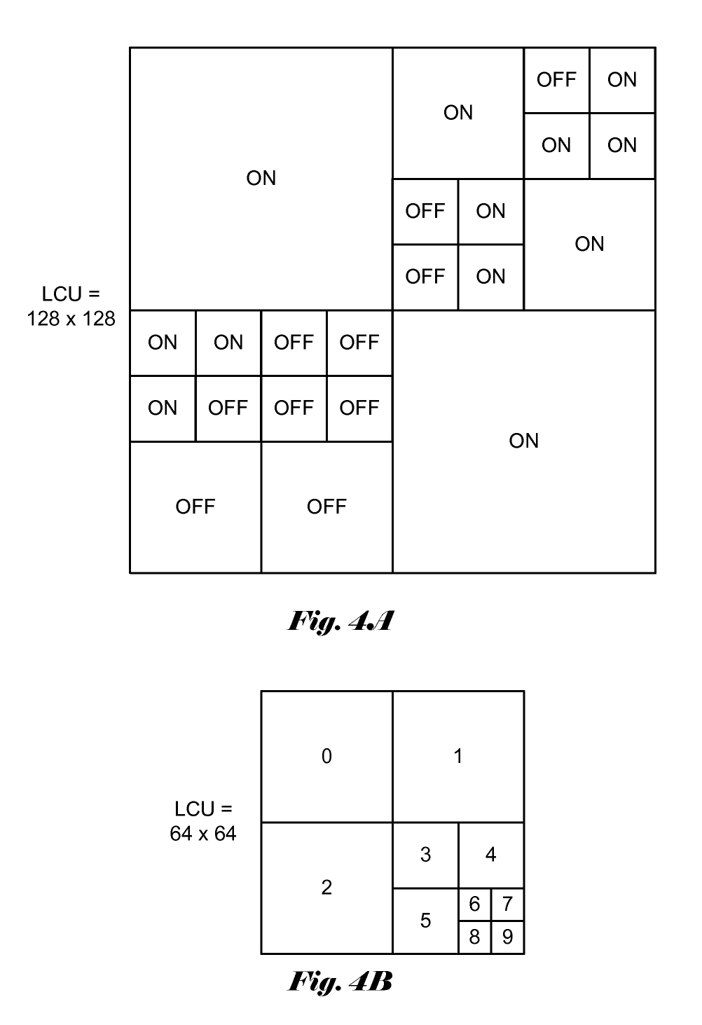

FIG. 4A illustrates an example of ALF flags for an LCU, where the LCU consists of 128×128 pixels. The LCU is partitioned into 22 blocks for processing, where the smallest CU has a size of 16×16 pixels. A 1-bit flag can be used to signal whether the associated block has the ALF operation turned ON or OFF. The 22 blocks (or 22 CUs) will require 22 bits to represent the ALF flags required for the LCU. Some coding technique such as entropy coding may be used to reduce the side information to be transmitted. In some applications, the smallest block size for ALF may not be the same as the smallest CU. In the case that the smallest CU size is smaller than the smallest ALF block size, the CUs within the smallest ALF block will share the same ALF flag. In other words, all CUs within the smallest ALF block will all have ALF turned ON or all have ALF turned OFF. FIG. 4B illustrates an example where the smallest CU is smaller than the smallest ALF block. In FIG. 4B, the LCU has a size 64×64 and the SCU has a size of 8×8 pixels. On the other hand, the smallest ALF block has a size of 16×16 pixels. Accordingly, the four smallest CUs, labeled as 6, 7, 8 and 9 in FIG. 4B share a single ALF flag while all other CUs has their individual ALF flags.

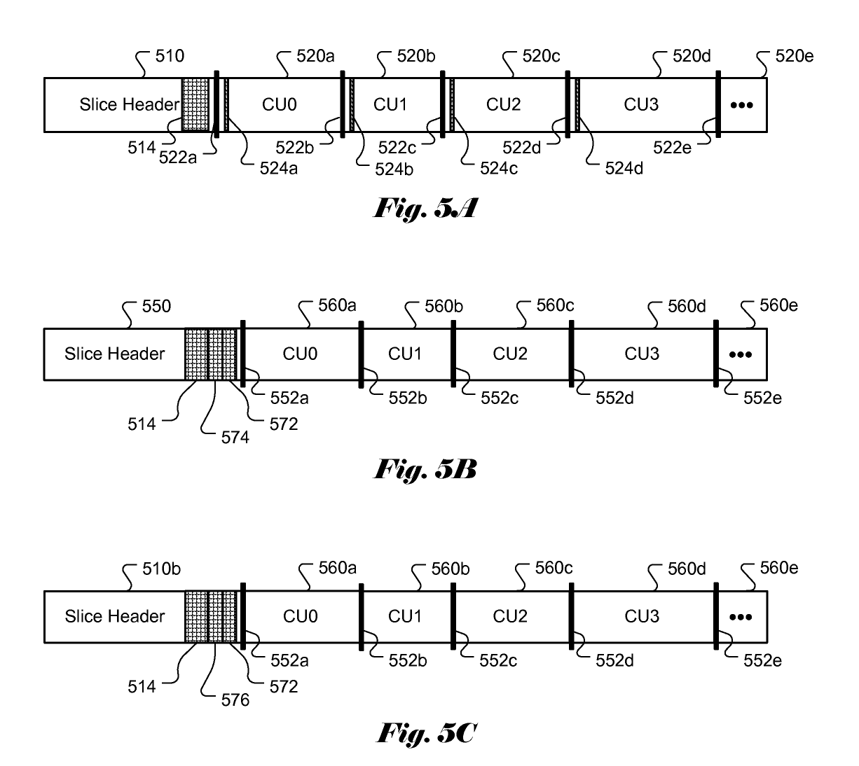

FIG. 3 illustrates a coding system incorporating ALF. While deblocking 310 is utilized to process the reconstructed frame, the use of deblocking is not required to practice ALF and ALF may be applied to a reconstructed frame without being deblocked. For each CU, the CU data will go through prediction process, DCT, quantization and entropy coding. The bit stream associated with the CU after entropy coding 130 is ready for transmission or storage in a selected format. In a conventional approach, data specifically associated with each coding unit will be put together in a structured fashion. Therefore, the ALF flag for each CU will be put together with the bitstream for the CU. FIG. 5A illustrates an exemplary data structure according to a conventional coding method, where the slice header 510a comprises filter gcoefficients 514 followed by bitstream for coding units in the slice. The slice comprises data for a group of coding units 520a through 520e separated by virtual coding unit boundaries) 522a through 522e. For each CU data, it contains a respective ALF flag 524a through 524d. The ALF process will train the filter coefficients based on data in a slice and each CU of the slice will be tested to determine whether to apply the ALF process. Therefore, the ALF flag for each CU will not be available until after all reconstructed CUs in the slice are available for the ALF process to derive the filter coefficients. Usually the ALF flag will be placed in the header portion of the CU data along with other information for the CU, such as those associated with coding mode and motion. The bitstream corresponding to compressed data for the CU usually is appended after the header portion. Consequently the data for all CUs in the slice may have to be temporarily buffered before the ALF flags are generated. This will increase system memory requirement as well as encoding latency and memory access. There is a need for a new method and bitstream format to overcome the issue associated with ALF flags.

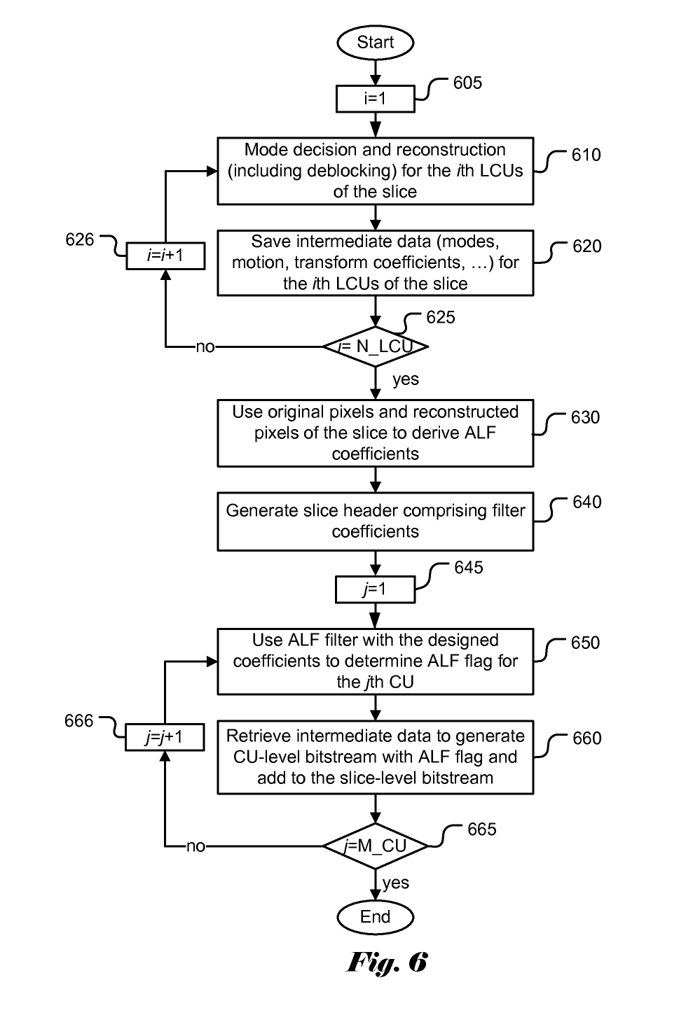

The data processing corresponding to a conventional method to generate bitstream for a slice is shown in FIG. 6. A counter i is initialized to 1 in step 605 to count the LCU in the slice. The mode decision and reconstruction for the ith LCU is performed in step 610 and the total number of LCUs is designated by N_LCU. For all LCUs in the slice, the coding mode has to be determined and information associated with the mode decision will be packed in the CU-level bitstream. The process of mode decision is not explicitly shown in FIG. 3. However, the process may be performed in intra/inter prediction 110 and the techniques for mode decision are well known in the field of video coding. At this time when individual CU is coded, the ALF flags are not yet available and the intermediate data for the ith LCUs in the slice related to mode, motion, transform coefficients and etc. have to be buffered in a temporary storage as shown in step 620. The system then checks if the LCU is the last LCU of the slice (step 625). If the LCU is the last LCU, the system goes to step 630, otherwise the counter i is incremented in step 626 and the system continues to process the next LCU (step 610). Upon the availability of all reconstructed CUs for the slice, the ALF filter coefficients can be derived based on the reconstructed pixels and the original pixels for the slice as shown in step 630. After the ALF filter coefficients are obtained for the slice, the slice header can be generate by including the filter coefficients in the slice header, step 640. The system is then ready to process the CU-level bitstream. A count j is initialized in step 645 to count the CU in the slice. The total number of CUs is designated as M_CU. The jth CU is processed to determine if the ALF will be ON or OFF for the CU and the ALF flag is generated accordingly for the jth CU as shown in step 650. After the ALF flag for the jth CU is determined, the CU-level bitstream can be generated by retrieving the intermediate data and incorporating the respective ALF flag in the header portion of the CU-level bitstream in step 660. The system will determine if the CU is the last CU of the slice in step 665. If yes, the data processing is completed and otherwise the counter j is increment in step 666 and the process continues to the next CU. In the above example, the smallest CU is assumed to be the same size as the smallest ALF block. In case that the smallest CU is smaller than the ALF block, the flowchart has to be modified to take care of ALF flag sharing.

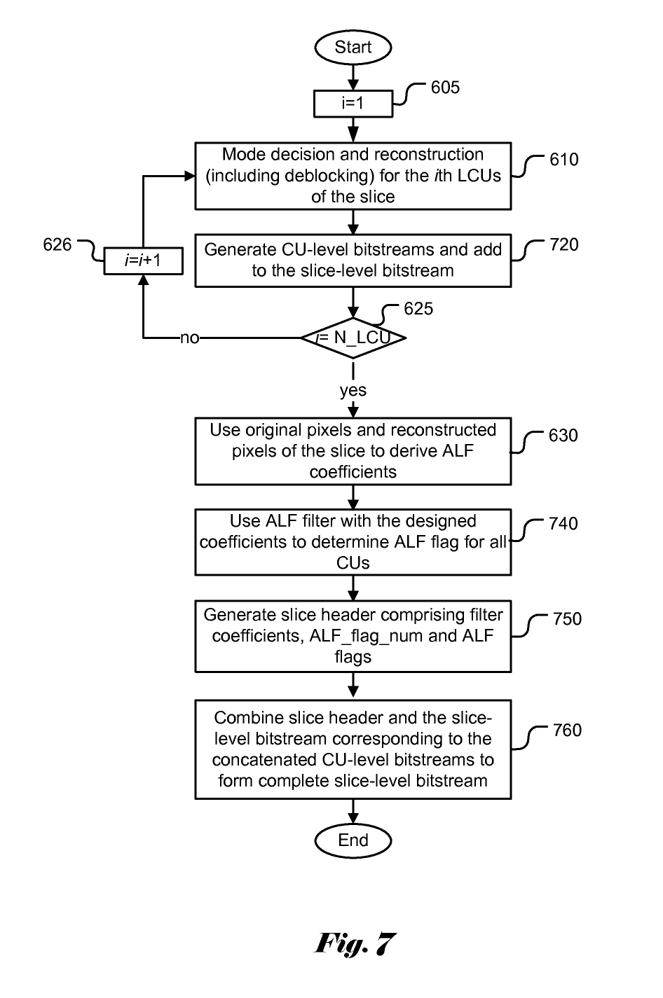

To overcome the ALF flags issue described above, a slice format according to one embodiment of the present invention is shown in FIG. 5B, where the ALF flags are carried in the slice header 550 instead of individual CU-level bitstream. The ALF_Flags 572 contains ALF flags for all CUs in the slice. Since the number of CUs resulted from the quadtree partition is variable, the number of total ALF flags in the slice needs to signaled. Accordingly, the number of total ALF flags, ALF_flag_num 574 is also carried in the slice header 550. The CU-level bitstreams are labeled as 560a through 560e with boundaries 552a through 552e as shown in FIG. 5B. Since the ALF flag is not packed in the CU-level bitstream, the CU-level bitstream can be generated at the end of processing each individual CU where the information required for the CU-level bitstream is readily available. The associated data processing to generate the slice bitstream according to one embodiment of the present invention is shown in FIG. 7. After the mode decision and reconstruction is made for each LCU, the CUs within the LCU are ready to generate the CU-level bitstreams in step 720 since ALF flag is not within the CU-level bitstream. The process is continued until all LCUs are processed to generate respective CU-level bitstreams. After reconstruction of all CUs in the slice is completed, the system can derive the filter coefficients for the slice as shown in step 630. The ALF filter designed according to step 630 is then tested for each CU to determine the ALF flag for the CU as shown in step 740. A slice header according to the present invention can be generated to include filter coefficients 514, the total number of CUs in the slice, ALF_flag_num 574, and ALF flags, ALF_Flags 572 as shown in FIG. 750. The slice header is then combined with the rest of the slice-level bitstream corresponding to the CU-level bitstreams generated in loop associated with counter i. Again, the example in FIG. 7 assumes that the smallest CU is no smaller than the smallest ALF block and therefore each CU will has its own ALF flag. If the smallest CU is smaller than the smallest ALF block, all CUs within the ALF block will share the same ALF flag. In this case, the flowchart in FIG. 7 has to be modified accordingly.

While the total number of ALF flags, ALF_flag_num 574 can be explicitly carried in the slice header, a coded form of ALF_flag_num may be used to reduce the amount of information required to carry ALF_flag_num. Assume there is a known number of LCUs , LCU_num, in each slice. The ALF_flag_num will be no smaller than the known number of LCUs in the slice. Consequently, the difference, termed ALF_flag_num_minus_LCU_num, between the number of CUs in the image area, ALF_flag_num, and the known number of LCUs in the image area, LCU_num, can be used to reduce the data size required. The difference can be coded using unsigned exponential Golomb code to further reduce the data size required. When the number of LCUs can be known for each slice after the size of LCU is determined, there is no need to transmit LCU_num. Therefore, in this case the ALF_flag_num can be recovered from the transmitted ALF_flag_num_minus_LCU_num according to ALF_flag_num=ALF_flag_num_minus_LCU_num+LCU_num. The difference 576 corresponding to ALF_flag_num_minus_LCU_num as shown in FIG. 5C is included in the slice header instead of the ALF_flag_num 574. In this case, ALF_flag_num is predicted by LCU_num in a conservative way. Because LCU num is always smaller than ALF_flag_num, the ALF_flag_num_minus_LCU_num is always positive and can be coded using unsigned exponential Golomb code. In another example, a more aggressive method can be used to let a predicted_ALF_flag_num closer to and may exceed the ALF_flag_num as long as the predicted_ALF_flag_num is pre-specified or can be derived on the decoder side. In this case, the prediction error of ALF_flag_num has to be coded using signed exponential Golomb code. In yet another example, the difference, termed ALF_flag_num_delta, between the current ALF_flag_num, ALF_flag_num(t) and the one corresponding to a previous slice or a previous frame, ALF_flag_num(t-1) can be used to reduce the data size required. The difference can be coded using signed exponential Golomb code to further reduce the data size required. In this case, the difference 576 in FIG. 5C is associated with the ALF_flag_num_delta. Alternatively, both of the above ALF flag number prediction methods may be used. In an embodiment, a syntax, ALF_flag_numpred, may be used to indicate the type of prediction used to form the difference. The syntax ALF_flag_numpred can be carried in the slice header to switch between different ALF flag number prediction methods. It is also possible to transmit the number of bits for coding ALF flags “ALF_flag_bit_num” instead of the total number of ALF flags or ALF flag number difference. The number of bits for coding ALF flags can be explicitly transmitted in either the slice header or picture-level header. In another embodiment, the number of bits for coding ALF flags can be implicitly derived by the decoders, for example, if a fixed length code is used for coding the ALF flags.

To reduce the complexity of bitstream catenation after the ALF process, encoders may make the bitstream having byte alignment on each boundary between the slice header and the corresponding slice data.

The advantage of the present invention becomes apparent by comparing the flowcharts in FIG. 6 and in FIG. 7. The flowchart according to a conventional approach as shown in FIG. 6 contains two loops: one associated with counter i and the other associated with counter j. In the loop associated with counter i the intermediate data from each LCU is buffered in a temporary storage as shown in step 620. Therefore, storage space has to be provided to buffer the intermediate data. The intermediate data are accessed again later to generate CU-level bitstreams as shown in step 660. On the other hand, the flowchart of FIG. 7 can generate CU-level bitstreams whenever the processing of a CU is complete since there is no need to wait for the completion of all CUs of the slice. Consequently, the embodiment according to the present invention as shown in the example of FIG. 7 is more efficient in storage space and reduces required data access and encoding latency.

The invention may also involve a number of functions to be performed by a computer processor, a microprocessor, a digital signal processing (DSP) module, or a field programmable gate array (FPGA). These processors may be configured to perform particular tasks according to the invention, by executing machine-readable software or firmware codes that define the particular tasks embodied by the invention. These processors may also be configured to operate and communicate with other devices such as memory devices, storage device and network devices. The memory devices may include random access memory (RAM), read only memory (ROM), electrical programmable ROM (EPROM), and flash memory (Flash). The storage devices may include optical drive and hard drive. The software and firmware codes may be configured using high-level software formats such as Java, C++, and other languages that may be used to define functions that relate to operations of devices required to carry out the functional operations related to the invention. The software and firmware codes may be configured using low-level software formats such as assembly language or other processor specific formats. The codes may be written in different forms and styles, many of which are known to those skilled in the art. Different code formats, code configurations, styles and forms of software programs and other means of configuring code to define the operations of a processor in accordance with the invention will not depart from the spirit and scope of the invention.

The invention may be embodied in other specific forms without departing from its spirit or essential characteristics. The invention may be embodied in hardware such as integrated circuits (IC) and application specific IC (ASIC), software and firmware codes associated with a processor implementing certain functions and tasks of the present invention, or a combination of hardware and software/firmware. The described examples are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for coding unit-synchronous adaptive loop filtering (ALF) for an image area that is partitioned into a plurality of coding units, the method comprising:
processing each of the coding units to generate a CU-level bitstream;
reconstructing said each of the coding units;
deriving filter coefficients for an ALF filter based on original pixels and reconstructed pixels of the image area;
determining ALF flags for the plurality of coding units using the ALF filter;
applying the ALF filter to the plurality of coding units according to the ALF flags; and
generating image area header, wherein the image area header comprises the filter coefficients and the ALF flags.

2. The method of claim 1, further comprising a step of deblocking said each of the coding units after said reconstructing said each of the coding units.

3. The method of claim 1, wherein the image area header comprises first information representing a number of coding units in the image area.

4. The method of claim 3, wherein the first information is related to a difference between the number of coding units in the image area and a predicted number of coding units in the image area.

5. The method of claim 4, wherein the predicted number of coding units in the image area is larger than or equal to the number of coding units in the image area and the difference is coded using unsigned exponential Golomb code.

6. The method of claim 5, wherein the predicted number of coding units is a number of largest coding units in the image area.

7. The method of claim 4, wherein the difference is coded using signed exponential Golomb code.

8. The method of claim 7, wherein the predicted number of coding units is a number of coding units in a previous image area.

9. The method of claim 7, wherein the predicted number of coding units is calculated using a number of largest coding units or a number of smallest coding units.

10. The method of claim 3, wherein the image area header comprises second information representing a prediction type associated with the first information.

11. The method of claim 1, wherein the image area header comprises first information representing a number of bits for coding the ALF flags.

12. The method of claim 1, wherein the image area is selected from a group consisting of a slice, a picture, and a frame.

13. The method of claim 1, wherein deriving filter coefficients for an ALF filter is based on Wiener filter.

14. The method of claim 1, wherein the ALF filter is applied to a block larger than a smallest coding unit and a single ALF flag is assigned to all coding units within the block.

15. The method of claim 1, wherein the coding units associated with the image area is created by dividing the image area into a plurality of largest coding units and partitioning each of the plurality of largest coding units into smaller coding units using a quadtree structure.

16. An apparatus to perform coding unit-synchronous adaptive loop filtering (ALF) for an image area that is partitioned into a plurality of coding units, the apparatus comprising:
a video coding module to process each of the coding units to generate a CU-level bitstream;
a reconstruction module to reconstruct each of the coding units;
a first processing module to derive filter coefficients for an ALF filter based on original pixels and reconstructed pixels of the image area;
a second processing module to determine ALF flags for the plurality of coding units using the ALF filter;
a filter module to perform adaptive loop filtering for the plurality of coding units using the ALF filter according to the ALF flags; and
a data packing module to generate image area header, wherein the image area header comprises the filter coefficients and the ALF flags.

17. A computer-readable data storage device having instructions carried thereon, the instructions being executable by a computer or a digital signal processing unit to perform a method of coding unit-synchronous adaptive loop filtering (ALF) for an image area that is partitioned into a plurality of coding units, the method comprising:
processing each of the coding units to generate a CU-level bitstream;
reconstructing each of the coding units;
deriving filter coefficients for an ALF filter based on original pixels and reconstructed pixels of the image area;
determining ALF flags for the plurality of coding units using the ALF filter;
applying the ALF filter to the plurality of coding units according to the ALF flags; and
generating image area header, wherein the image area header comprises the filter coefficients and the ALF flags.

18. A decoding method for a video system employing coding unit-synchronous adaptive loop filtering (ALF) for an image area that is partitioned into a plurality of coding units, wherein an image area-level bitstream associated with the image area comprises an image area-level header and CU-level bitstreams associated with the plurality of coding units, the method comprising:
receiving the image area-level bitstream corresponding to the image area;
providing filter coefficients for an ALF filter according to the image area-level header;
providing ALF flags according to the image area header, wherein the ALF flags are associated with the plurality of coding units of the image area;
reconstructing each of the coding units according to the CU-level bitstreams to generate a reconstructed coding unit; and
applying the ALF filter to the reconstructed coding unit adaptively according to one of the ALF flags associated with the reconstructed coding unit.

19. The method of claim 18, further comprising a step of deblocking said each of the coding units after said reconstructing said each of the coding units.

20. The method of claim 18, wherein the image area header comprises first information representing a number of coding units in the image area, the method further comprising a step of utilizing the first information for providing ALF flags according to the image area header.

21. The method of claim 20, wherein the first information is related to a difference between the number of coding units in the image area and a predicted number of coding units in the image area, the method further comprising a step of utilizing the difference for said providing ALF flags according to the image area header.

22. The method of claim 21, wherein the predicted number of coding units in the image area is larger than or equal to the number of coding units in the image area and the difference is coded using unsigned exponential Golomb code.

23. The method of claim 22, wherein the predicted number of coding units is a number of largest coding units in the image area.

24. The method of claim 21, wherein the difference is coded using signed exponential Golomb code.

25. The method of claim 24, wherein the predicted number of coding units is a number of coding units in a previous image area.

26. The method of claim 24, wherein the predicted number of coding units is calculated using a number of largest coding units or a number of smallest coding units.

27. The method of claim 20, wherein the image area header comprises second information representing a prediction type associated with the first information, the method further comprising a step of selecting the prediction type to according to the second information to recover the first information.

28. The method of claim 18, wherein the image area header comprises first information representing a number of bits for coding the ALF flags in the image area, the method further comprising a step of utilizing the first information for providing ALF flags according to the image area header.

29. The method of claim 18, wherein the image area is selected from a group consisting of a slice, a picture, and a frame.

30. The method of claim 18, wherein the plurality of the coding units associated with the image area is created by dividing the image area into a plurality of largest coding units and partitioning each of the plurality of largest coding units into smaller coding units using a quadtree structure.

31. An apparatus to perform decoding for a video system employing coding unit-synchronous adaptive loop filtering (ALF) for an image area that is partitioned into a plurality of coding units, wherein an image area-level bitstream associated with the image area comprises an image area-level header and CU-level bitstreams associated with the plurality of coding units, the apparatus comprising:
an interface module to receive the image area-level bitstream corresponding to the image area;
a first processing module to provide filter coefficients for an ALF filter according to the image area-level header;
a second processing module provide ALF flags according to the image area header, wherein the ALF flags are associated with the plurality of coding units of the image area;
a reconstruction module to reconstruct each of the coding units according to the CU-level bitstreams to generate a reconstructed coding unit; and
a filter module to perform adaptive loop filtering for the plurality of coding units using the ALF filter according to the ALF flags.

32. A computer-readable data storage device having instructions carried thereon, the instructions being executable by a computer or a digital signal processing unit to perform decoding method for a video system employing coding unit-synchronous adaptive loop filtering (ALF) for an image area that is partitioned into a plurality of coding units, wherein an image area-level bitstream associated with the image area comprises an image area-level header and CU-level bitstreams associated with the plurality of coding units, the method comprising:
receiving the image area-level bitstream corresponding to the image area;
providing filter coefficients for an ALF filter according to the image area-level header;
providing ALF flags according to the image area header, wherein the ALF flags are associated with the plurality of coding units of the image area;
reconstructing each of the plurality of coding units according to the CU-level bitstreams to generate a reconstructed coding unit; and
applying the ALF filter to the reconstructed coding unit adaptively according to one of the ALF flags associated with the reconstructed coding unit.
